(19) United States
(12) Patent Application Publication
(10) Pub. No.: US 2016/0062456 A1
(43) Pub. Date: Mar. 3, 2016

(54) METHOD AND APPARATUS FOR LIVE USER RECOGNITION

(71) Applicant: NOKIA TECHNOLOGIES OY, Espoo (FI)

(72) Inventors: Kongqiao WANG, Beijing (CN); Wendong WANG, Beijing (CN); Bo ZHANG, Beijing (CN)

(21) Appl. No.: 14/784,230

(22) PCT Filed: May 13, 2014
(86) PCT No.: PCT/FI2014/050352

§ 371 Date: Oct. 13, 2015

(30) Foreign Application Priority Data
May 17, 2013 (CN) 201310193848.6

(51) Int. Cl. G06F 3/01; G06K 9/00

(52) U.S. Cl. CPC G06F 3/013; G06K 9/00255; G06K 9/00597; G06K 9/00906

(57) ABSTRACT

Embodiments of the present invention relate to a method and apparatus for live user recognition. There is disclosed a method for live user recognition. The method comprises: obtaining an image containing a face; while recognizing the face based on the image, detecting whether gaze of the face moves into proximity of a random position on a display screen every time an object is displayed at the random position; and determining whether the image is obtained from the live user based on the detection. The corresponding apparatus is disclosed as well.

### FIELD OF THE INVENTION

Embodiments of the present invention relates to computing technology, and more specifically, to a method and apparatus for live user recognition.

### BACKGROUND OF THE INVENTION

With the development of image/video processing and pattern recognition technology, face recognition has become a stable, accurate and efficient biometrics recognition technology. Face recognition takes an image and/or video containing a face as input and determines a user's identity by recognizing and analyzing facial features. Compared with iris recognition or other biometrics-based technology, face recognition can complete identity authentication efficiently without user focus and awareness, thereby causing slight disturbance to users. Therefore, face recognition has been widely applied to identity authentication in finance, justice, public safety, military and various respects in human daily life. Moreover, face recognition can be implemented by means of various user terminals like a personal computer (PC), a mobile phone, a personal digital assistant (PDA) and so on, without precision and expensive specialized instruments.

However, there also exist some drawbacks in face recognition-based identity authentication. For example, an image/video containing a legal user's face might be obtained by an illegal user using various means, such as via public web albums, personal resumes, pinhole cameras, etc. Then, the illegal user might place such image/video (such as legal users' facial photos) in front of an image acquisition device so as to input it into a face recognition system, thereby breaking into the legal user's accounts. Conventional face recognition systems are unable to cope with such situation, because they are unable to detect whether the inputted user facial image is obtained from a live user.

To alleviate this problem, pre-processing to a facial image such as three-dimensional depth analysis, blink detection and/or spectrum sensing has been proposed, thereby determining whether the recognized facial image is obtained from a live user or from a two-dimensional image like users' photo. However, this method imposes strict requirements on operating environment. In addition, the method cannot differentiate between live users and video containing faces, because faces in video may also have three-dimensional depth information and actions like blinks. Other known methods require before face recognition, users' specific parts (such as hands or eyes) perform predetermined actions, for example moving along a predetermined path. However, since these predetermined actions are relatively fixed, illegal users might record actions performed by legal users during identity authentication and use recorded video clips to simulate live users. Moreover, these methods request users to remember predetermined actions, which increases interaction burden on users. Solutions using infrared detection and other means to measure human temperature and thus recognize live users are also known. However, these solutions have to be implemented by means of specialized devices, thereby increasing complexity and/or costs of the face recognition systems.

In view of the foregoing discussion, there is a need in the art for a technical solution capable of live user recognition more effectively, accurately and conveniently.

### SUMMARY OF THE INVENTION

To overcome the above problems, the present invention proposes a method and apparatus for live user recognition.

According to one aspect of the present invention, there is provided a method for live user recognition. The method comprises: obtaining an image containing a face; while recognizing the face based on the image, detecting whether gaze of the face moves into a proximity of a random position on a display screen every time an object is displayed at the random position; and determining whether the image is obtained from the live user based on the detection.

According to another aspect of the present invention, there is provided an apparatus for live user recognition. The apparatus comprises: an image obtaining unit configured to obtain an image containing a face; a gaze detecting unit configured to detect, while recognizing the face based on the image, whether gaze of the face moves into a proximity of a random position on a display screen every time an object is displayed at the random position; and a live user recognizing unit configured to determine whether the image is obtained from the live user based on the detection.

It would be appreciated from the following description that according to embodiments of the present invention, while performing face recognition to a user, whether a facial image is obtained from a live user can be recognized rapidly and effectively through the movement of the gaze to a random position on the screen. Moreover, according to embodiments of the present invention, illegal users can hardly pretend to be legal users by using facial images and/or video acquired in advance. In addition, since the solution's working principle is based on conventional physiological properties of the human body (such as the stress response), so the user burden can be maintained at acceptable lower level. The method and apparatus according to embodiments of the present invention can be conveniently implemented using a common computer device without a need for any dedicated device or instrument, thereby helping to reducing the cost.

### BRIEF DESCRIPTION OF THE DRAWINGS

Through the detailed description with reference to the accompanying drawings, the above and other objects, features and advantages of the present invention will become easier to be understood. In the accompanying drawings, there are shown several embodiments of the present invention in an illustrative manner rather than limiting.

FIG. 1 shows an exemplary block diagram of hardware configuration of an environment in which embodiments of the present invention may be implemented;

FIG. 2 shows a schematic flowchart a method for live user recognition according to one exemplary embodiment of the present invention;

FIG. 3 shows a schematic block diagram of live user recognition by implementing the method shown in FIG. 2;

FIG. 4 shows a schematic flowchart of a method for live user recognition according to one exemplary embodiment of the present invention;

FIG. 5 shows a schematic block diagram of a time relationship between object displaying and gaze detecting according to one exemplary embodiment of the present invention;

FIGS. 6A to 6D show a schematic block diagram of live user recognition by implementing the method shown in FIG. 4;

FIG. 7 shows a schematic block diagram of an apparatus for live user recognition according to one exemplary embodiment of the present invention; and

FIG. 8 shows a schematic block diagram of a device which is applicable to implement the exemplary embodiments of the present invention.

The same or corresponding numerals generally refer to the same or corresponding parts throughout the figures.

### DETAILED DESCRIPTION OF EMBODIMENTS

Description is presented below to principles and spirit of the present invention with reference to several embodiments in the accompanying drawings. It should be understood these embodiments are described only for enabling those skilled in the art to better understand and thus implement the present invention, rather than limiting the scope of the present invention in any manner.

Reference is first made to FIG. 1 which shows a schematic block diagram of hardware configuration of a system 100 in which the exemplary embodiments of the present invention may be implemented. As shown in this figure, system 100 comprises an image capture device 101 for capturing an image containing the user's face. According to embodiments of the present invention, image capture device 101 may include, without limitation to, a camera, a video camera, or any other appropriate device capable of capturing static and/or dynamic images.

System 100 further comprises a display screen (hereinafter referred to as a “screen” for short) 102 for presenting information to the user. According to embodiments of the present invention, screen 102 may be any device capable of presenting visualized information to the user, including without limitation to one or more of: a cathode ray tube (CRT) display, a liquid crystal display (LCD), a light-emitting diode (LED) display, a plasma display panel (PDP), a 3-dimensional display, a touch display, etc.

Note although image capture device 101 and display screen 102 are shown as separate devices in FIG. 1, the scope of the present invention is not limited thereto. In some embodiments, image capture device 101 and display screen 102 may be located on the same physical equipment. For example, where a mobile device is used to perform identity authentication to the user, image capture device 101 may be a camera of the mobile device, while display screen 102 may be a screen of the mobile device.

Optionally, system 100 may further comprise one or more sensors 103 for capturing one or more parameters indicative of environment state where the user is located. In some embodiments, sensor 103 may include for example one or more of: parameters captured by sensor 103 are only used to support optional functions in some embodiments, while live user recognition does not rely on these parameters. Concrete operations and functions of sensor 103 will be described in detail below. Like the foregoing description, sensor 103 may also be located on the same physical equipment as image capture device 101 and/or display screen 102. For example, in some embodiments, image capture device 101, display screen 102 and sensor 103 may be components of the same user equipment (such as a mobile phone), and they may be coupled to a central processing unit of the user equipment.

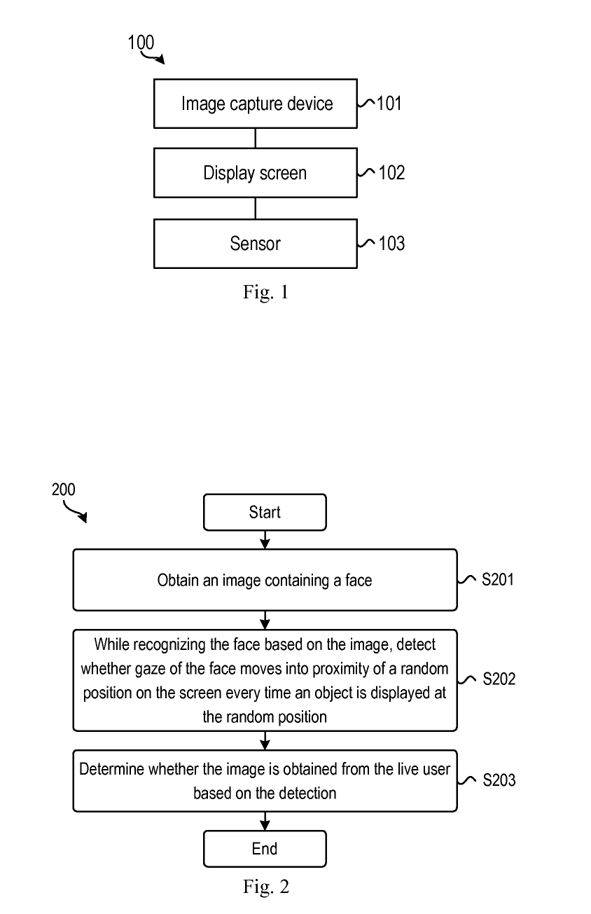

FIG. 2 shows a schematic flowchart of a method 200 for live user recognition according to one exemplary embodiment of the present invention. After method 200 starts, at step S201 an image containing a face is obtained. As described above, the facial image in any appropriate format may be obtained by means of image capture device 101 of system 100. In particular, the facial image may be one or more frames in captured video. Here according to some embodiments of the present invention, an original image, after being captured, may undergo various pre-processing and/or format conversion so as to be used for subsequent live user detection and/or face recognition. In this regard, any image/video recognition techniques that are currently known or to be developed in future may be used in conjunction with embodiments of the present invention, and the scope of the present invention is not limited.

Next method 200 proceeds to step S202. At step S202, while recognizing the face based on the image obtained at step S201, every time an object is displayed at a random position on the screen, it is detected whether or not the face's gaze moves into proximity of that random position.

During operation, after obtaining an image at step S201, the image may be processed to recognize facial features and information contained in the image. Any face recognition and/or analysis method, no matter currently known or developed in future, may be used in conjunction with embodiments of the present invention, and the scope of the present invention is not limited in this regard. In parallel to face recognition, one or more objects may be displayed to the user by the display screen 102, so as to detect whether or not the currently processed image is obtained from a live user. According to embodiments of the present invention, live user detection is implemented concurrently with face recognition. This is because if they are not executed concurrently, then an illegal user might use a facial photo/video for face recognition and use a face of another (illegal) live user to pass live user recognition. Embodiments of the present invention can effectively discover and eliminate occurrence of such a phenomenon.

Still with reference to FIG. 2, at step S202, each object is displayed at a randomly determined position on the screen. When more than one object is to be displayed on the screen, these objects may be displayed on screen 102 sequentially in temporal order and each of them is displayed at a corresponding random position on the screen. In particular, prior to displaying a next object, display of the current object may be removed from the screen, which will be described in detail. It would be understood that displaying an object at a random position on the screen allows effective recognition of a live user. Since an object is displayed at a random position on the screen each time, a non-live user (such as a photo or video containing a face) cannot move the gaze to the corresponding position in response to display of the objects.

According to some embodiments of the present invention, the displayed object may be a bright spot. Alternatively, the displayed object may be text, icon, pattern, or any appropriate content that may draw the user's attention. Compared with background presented by display screen 102, the object may be highlighted in order to draw sufficient attention from the user. For example, the displayed object may differ from the screen background in following one or more respects: color, brightness, shape, action (for example, the object may rotate, jitter, zoom, etc.), etc.

According to embodiments of the present invention, while implementing face detection, the image capture device 102 is configured to continuously capture images containing the user's face. Thus, every time an object is displayed at a random position on the display screen, a gaze tracking process is applied to a series of captured images, so as to detect whether or not the face's gaze moves to that random position where the object is displayed on the screen. A variety of gaze tracking techniques are known, which include without limitation to: shape-based tracking, feature-based tracking, appearance-based tracking, tracking based on mixed characteristics of geometric and optical features, etc. For example, there has been proposed a solution for human eye recognition and gaze tracking through an active shape model (ASM) or an active appearance model (AAM). In fact, any gaze detection and tracking methods that are currently known or to be developed in future may be used in conjunction with embodiments of the present invention, and the scope of the present invention is not limited in this regard.

In particular, considering possible errors in the gaze detection process, in implementation, the user's gaze does not necessarily completely match a screen position where an object is displayed. Rather, a predetermined proximity may be set, such as a circular area with a predetermined radius or a polygonal area with predetermined side lengths. In gaze detection, as long as the gaze falls within the predetermined proximity of the object position, it may be determined the gaze has moved to the screen position of the object.

Returning to FIG. 2, method 200 proceeds to step S203, where it is determined whether the image obtained at step S201 is obtained from the live user based on the detection at step S202. The operation here is based on physiological features of an organism. Specifically, when an object (e.g., bright spot) whose appearance differs from the background appears on the screen, the gaze of a live user will be consciously or sub-consciously drawn to the bright spot's position. Therefore, if it is detected at step S202 that the face's gaze moves to proximity of a random position on the screen every time an object is displayed at the random position, then at step S203 it may be determined the image containing a face is obtained from the live user.

Otherwise, if it is detected at step S202 the gaze does not move with an object displayed on the screen, then at step S203 it may be determined the image containing a face is possibly not obtained from the live user. At this point, any appropriate subsequent processing may be performed, e.g., further estimating the risk that the image is obtained from a non-live user, or directly leading to failure of the identity authentication process, etc.

Method 200 ends after step S203.

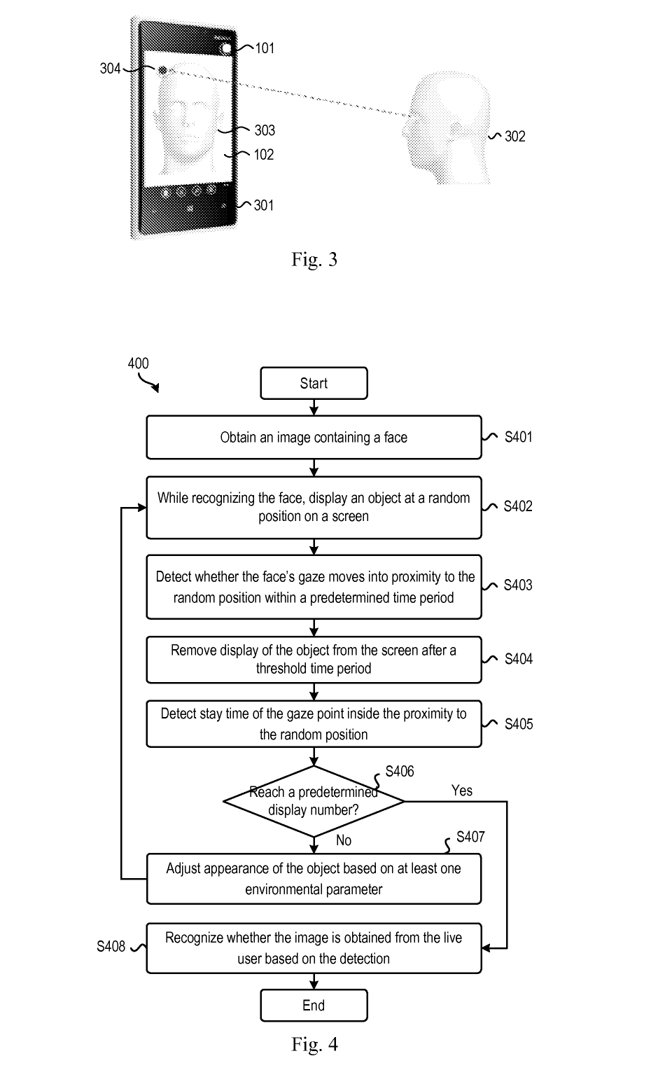

Now reference is made to FIG. 3 to discuss a specific example. In the example shown in FIG. 3, image capture device 101 and display screen 102 are components of same physical equipment 301. In operation, image capture device 101 is configured to capture an image 303 of the face of a user 302 and display facial image 303 on screen 102. While performing face recognition on the image, an object 304 is displayed at a random position on display screen 102. Then, if it is detected the gaze of user 302 moves to the random position of object 304, it may be determined the facial image being processed is obtained from a live user. Otherwise, if no movement of the gaze is detected after the object 304 is displayed on screen 102, then it may be determined there is a risk that the captured facial image comes from a non-live user.

It would be appreciated that the gaze in a static image like a photo cannot change, while the probability that the gaze in video exactly moves to a random position of an object on the screen after the object is displayed is quite low. Therefore, according to embodiments of the present invention, it is possible to effectively prevent illegal users from successfully passing face recognition-based identity authentication by using facial photos and/or video.

As described above, while performing face recognition, one object may be displayed on the screen 102. Alternatively, a plurality of objects may be sequentially displayed. FIG. 4 shows a method 400 for live user recognition with a plurality of objects being displayed on a screen according to one embodiment of the present invention. It would be appreciated that the method 400 may be regarded as a specific implementation of the method 200 described with reference to FIG. 2 above.

As shown in FIG. 4, after method 400 starts, at step S401 an image containing a face is obtained. This step corresponds to step S201 in method 200 that has been described with reference to FIG. 2 above, and various features described above are applicable here and thus not detailed any more.

Next at step S402, an object is displayed on a display screen while performing face recognition based on the obtained image. As described above, the displayed object may be, for example, a bright spot and may differ from the background of display screen 102 in various respects like color, brightness, shape, action and so on. In particular, the object's display position on the screen is determined at random.

Then the method 400 proceeds to step S403, where it is detected whether or not the gaze of the face under recognition moves into proximity of a random position on the screen within a predetermined time period in response to the object being displayed at the random position. It would be appreciated according to the embodiment as discussed herein, in addition to detecting whether the gaze moves into proximity of the object's position, it is detected whether such movement is completed within a predetermined time period. In other words, a time window may be set for the gaze detection. Only the gaze's movement to the object's position detected within this time window is considered valid. Otherwise, if the movement is beyond the time window, it is considered there is a risk that the image is obtained from a non-live user, even if the gaze moves into proximity of a random position of the displayed object,

According to the physiological stress response of organisms, when an obvious object appears on the screen, usually a live user will “gaze” at the object immediately. Moreover, such a physiological characteristic of organisms can hardly be simulated by manually manipulating facial images or video. Therefore, by detecting whether the gaze moves to the object's position within a sufficient time period, the accuracy of live user recognition can be enhanced further.

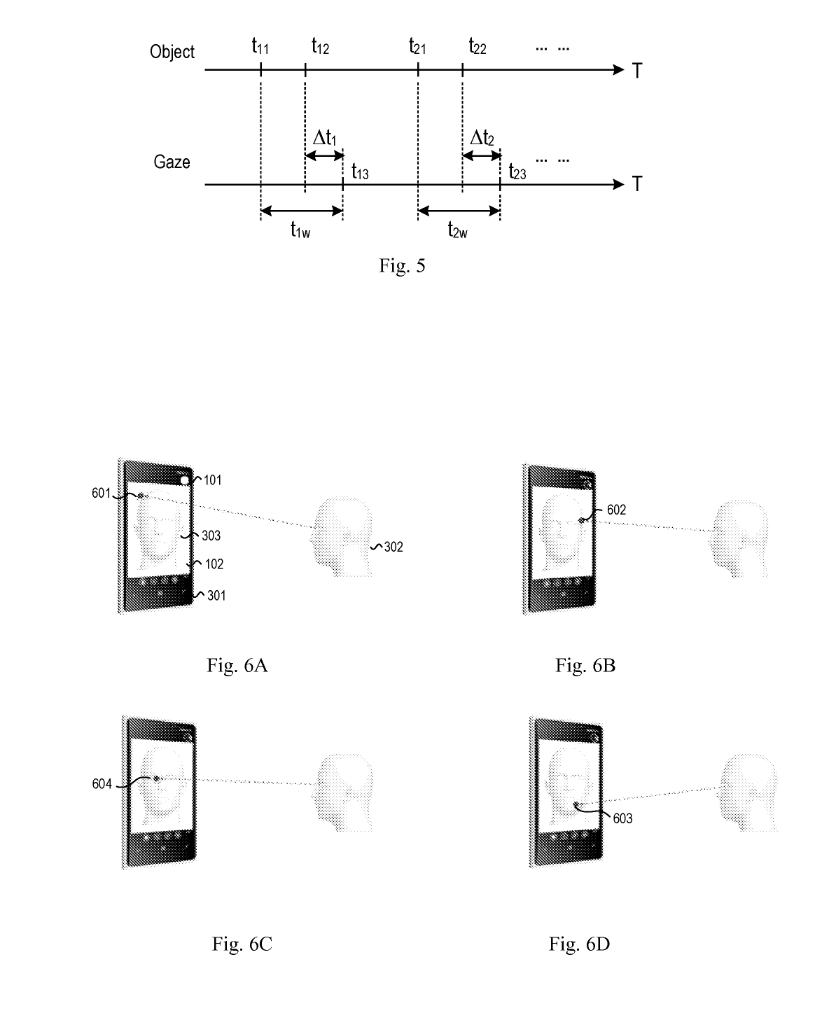

In order to further avoid the risk of misjudging a non-live user as a live user, optionally the duration that the object is displayed on the screen may be recorded. When the duration that the object is displayed on the screen reaches a threshold, at step S404 the display of the object on the screen is removed. With reference to FIG. 5, a concrete example is described in order to clearly depict a time relationship between object display and gaze detection.

As shown in FIG. 5, suppose an object (referred to as ‘a first object” for example) is displayed at a random position on the screen at an instant t₁₁. Accordingly, as seen from two time axes (T) shown in FIG. 5, it is detected from the instant t₁₁ whether the gaze moves a corresponding random position on the screen. The display of the object on the screen is removed at an instant t₁₂; that is, the duration that the object is displayed on the screen is a time period [t₁₁, t₁₂]. At an instant t₁₃ after the instant t₁₂, the gaze detection ends. In other words, a time window of the gaze detection is [t₁₁, t₁₃]. It can be seen that in this embodiment, there is an increment Δt₁ between the instant t₁₂ when the object is removed and the instant t₁₃ when the gaze detection ends. The time difference compensates the user's psychological delay. Specifically, usually there exists certain delay from the instant when an object is displayed on the screen to the instant when the user perceives the object and starts to move the gaze. By compensating the delay using the time increment Δt₁, the probability of misjudging a live user as a non-live user can be reduced. Alternatively, the psychological delay may also be compensated in a manner below: after the object is displayed at the instant t₁₁, the gaze detection is re-initiated after a specific delay.

Returning to FIG. 4, it should be understood both steps S403 and S404 are optional. Specifically, in some alternative embodiments, the gaze detection is not restrained by a time window. In other words, a time window of the gaze detection may be set as infinitely long. Alternatively or additionally, the object, after being displayed, may be kept on the screen rather than being removed after a threshold time. The scope of the present invention is not limited in this regard.

At optional step S405, the stay time of the gaze within the proximity of the displayed object's random position is detected. A time starting point of the stay time is the instant when the gaze moves into the proximity, while a time ending point is the instant when the gaze moves outside the proximity. The detected gaze stay time may be recorded for later live user recognition, which will be described in detail below.

Method 400 then proceeds to step S406, where it is detected whether the number of displayed objects reaches a predetermined threshold. According to embodiments of the present invention, the threshold may be a preset fixed number. Alternatively, the threshold may be randomly generated every time live user recognition is executed. If it is determined at step S406 that the threshold is not reached (branch “No”), then method 400 proceeds to step S407.

At step S407, at least one parameter indicative of environmental status (referred to as “environmental parameters” for short) is obtained, and an appearance of a to-be-displayed object is adjusted based on the environmental parameters. The environmental parameters may be obtained by means of one or more sensors 103 shown in FIG. 1. According to embodiments of the present invention, examples of the environmental parameters include without limitation to: temperature parameters, brightness parameters, spectrum parameters, color parameters, sound parameters, etc. The object's appearance may be dynamically adjusted based on these environmental parameters. For example, where the object is a bright spot, the bright spot's brightness and/or size may be dynamically adjusted according to brightness of the environment where the user is located, or the bright spot's color is adjusted according to color information of the user's environment, etc. In particular, as described above, environmental parameters collected by means of sensors 103 are only used for supporting some optional functions, such as adjusting the object's appearance. The live user recognition itself can be completed by the image capture device and the screen only, without depending on any other sensor parameter.

After step S407, method 200 returns to step S402, where another object (referred to as “a second object” for example) is displayed according to the appearance adjusted at step S407. In particular, according to some embodiments of the present invention, the second object's display position may be set such that it is sufficiently far away from the display position of the previously displayed first object. Specifically, suppose at a first instant, the first object is displayed at a first random position on the screen; at a second instant subsequently, the second object is displayed at a second random position on the screen. The distance from the second random position to the first random position may be made greater than a threshold distance. In implementation, after randomly generating a candidate display position of the second object, the distance from the candidate display position to a first random position may be calculated. If this distance is greater than a predetermined threshold distance, then the candidate display position is set as a second random position used for displaying the second object. Otherwise, if the distance is less than the predetermined threshold distance, then another candidate display position of the second object is generated, and the comparison is repeated until the distance from a candidate display position to the first random position is greater than the predetermined threshold distance. Advantageously, by ensuring the distance between display positions of two objects to be large enough, it makes the gaze movement more recognizable and further increase the accuracy of live user recognition.

At steps S403 to S405, the second object is processed in a similar way to the above processing to the first object. In particular, still with reference to FIG. 5, according to some embodiments of the present invention, when the display of the first object is removed at the instant t₁₂, the second object starts to be displayed at a subsequent second instant (an instant t₂₁ shown in FIG. 5). Afterwards, in response to the duration that the second object is displayed on the screen (a time period [t₂₂, t₂₁] shown in FIG. 5) reaching a predetermined threshold time, the display of the second object is removed at the instant t₂₂. In particular, it would be appreciated a time interval between objects displayed at two separate times (time period [t₂₂, t₂₁] shown in FIG. 5) may be fixed or varying (e.g., determined at random).

At step S406, if it is determined the predetermined display number is reached (branch “yes”), then method 400 proceeds to step S408, where it is recognized based on the detection at step S403 and/or step S405 whether the obtained image comes from the live user. Specifically, regarding any one object displayed on the screen, if it is detected at step S403 the gaze does not move into proximity of a random position where the object is located within the predetermined time period, then it is determined the image might be obtained from a non-live user.

Alternatively or additionally, at step S408 the actual stay time within which the gaze stays inside the proximity of the random position as obtained at step S405 may be compared with a predetermined threshold stay time. If the actual stay time is greater than the threshold stay time, then it is considered the gaze's stay is valid. Otherwise, if the actual stay time is less than the threshold stay time, then it is determined there is a risk that the image is obtained from a non-live user. For the purpose of convenient discussion, a non-live user risk (probability) value determined according to the detection on the ith object is recorded as Pᵢ (i=1, 2, . . . , N, wherein N is the number of displayed objects). Thereby, a sequence {P₁, P₂, . . . , P_{N}} consisting of risk values may be obtained at step S408. Later, according to some embodiments, an accumulated risk value (Σi Pᵢ) that the image is obtained from a non-live user may be calculated. If the accumulated risk value is greater than a threshold accumulated risk value, then it may be determined the image being processed currently is not obtained from the live user. Alternatively, in other embodiments, each separate risk value Pᵢ may be compared with an individual risk threshold. At this point, as an example, if the number of risk values Pᵢ that exceeds the individual risk threshold exceeds a predetermined threshold, then it may be decided the image being processed currently is not obtained from the live user. Other various processing approaches are also applicable, and the scope of the present invention is not limited in this regard.

If it is determined at step S408 that the image being processed currently is from a non-live user, various appropriate subsequent processing may be performed. For example, in some embodiments, the user's identity authentication may be rejected directly. Alternatively, further live user recognition may also be executed. At this point, for example the criterion for live user recognition may be enhanced accordingly, such as displaying more objects, shortening a display interval between multiple objects, etc. On the contrary, if it is determined at step S408 that the image being processed currently is from the live user, then the identity authentication is continued based on a result of face recognition. The scope of the present invention is not limited by any subsequent operation resulting from a result of the live user recognition.

Method 400 ends after step S408.

By sequentially displaying a plurality of objects at a plurality of random positions on the screen, the accuracy and reliability of the live user recognition may be further increased. A concrete example is now considered with reference to FIGS. 6A to 6D. In the example shown in FIG. 6, while performing the face recognition, a series of objects (4 in this example) 601 to 604 are sequentially displayed at different positions on screen 102. At this point, if the gaze in the facial image being processed currently moves to these random positions with the appearance of these objects, then it may be determined that facial image being processed currently is obtained from the live user. On the contrary, if after one or more of objects 601 to 604 are displayed on screen 102, it is not detected the gaze moves to display positions of these objects, then it may be determined there exists a risk of non-live user. It would be appreciated that the gaze in video might just fall within proximity of the position of a target object in an appropriate detection window (an event of small probability), this phenomenon would not happen repeatedly. Therefore, by displaying a plurality of objects at random positions on the screen, it is possible to better prevent illegal users from face recognition by using face video.

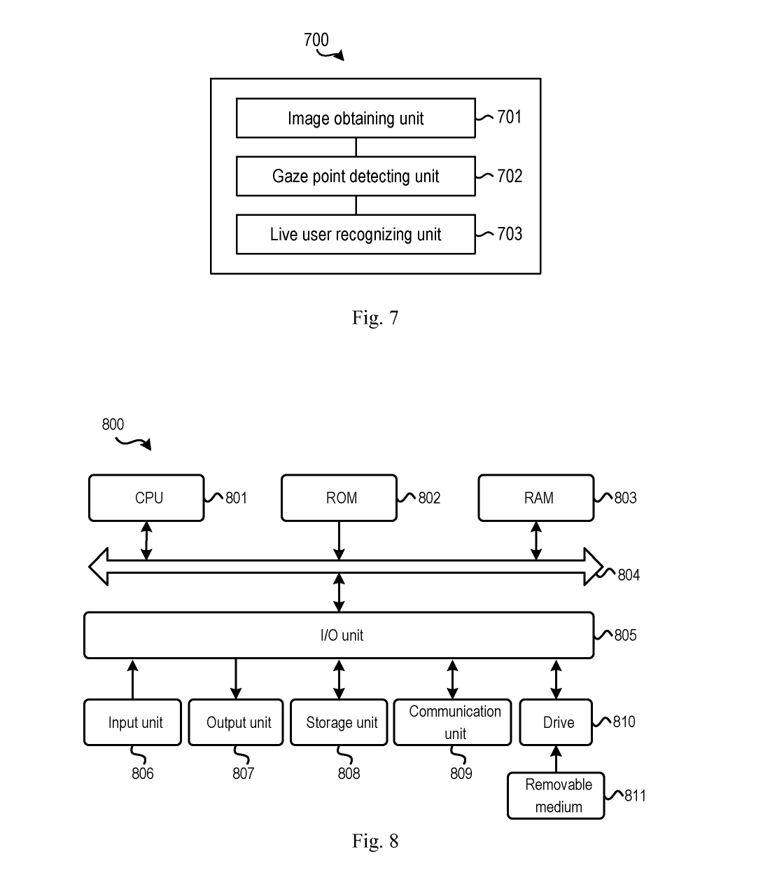

With reference to FIG. 7, this figure shows a schematic block diagram of an apparatus 700 for live user recognition according to one exemplary embodiment of the present invention. As shown in FIG. 7, apparatus 700 comprises: an image obtaining unit 701 configured to obtain an image containing a face; a gaze detecting unit 702 configured to detect, while recognizing the face based on the image, whether gaze of the face moves into a proximity of a random position on a display screen every time an object is displayed at the random position; and a live user recognizing unit 703 configured to determine whether the image is obtained from the live user based on the detection.

According to some embodiments, the gaze detecting unit 702 may comprise: a unit configured to detect whether the gaze of the face moves into the proximity of the random position in a predetermined time period after the object is displayed.

According to some embodiments, a first object is displayed at a first random position on the display screen at a first instant; a second object is displayed at a second random position on the display screen at a subsequent second instant, wherein a distance between the first random position and the second random position is greater than a predetermined threshold distance. Moreover according to some embodiments, before the second instant, the first object is removed from the display screen.

According to some embodiments, the duration for which an object is displayed on the display screen is less than a predetermined threshold time. Alternatively or additionally, according to some embodiments, apparatus 700 may further comprise: a stay time detecting unit (not shown) configured to detect a stay within which the gaze stays inside the proximity of the random position, so as to determine whether the image is obtained from the live user.

According to some embodiments, apparatus 700 may further comprise: an environmental parameter obtaining unit (not shown) configured to obtain at least one parameter indicative of environmental state; and an object appearance adjusting unit (not shown) configured to dynamically adjust the object's appearance based on the at least one parameter. Alternatively or additionally, the object differs from the background of the display screen in at least one respect: color, brightness, shape, action.

It should be understood that for the clarity purpose, FIG. 7 does not show optional units or sub-units contained in apparatus 700. It is to be understood that all features described with respect to FIGS. 2 and 4 are also applicable to apparatus 700. Moreover, the term “unit” used here may be a hardware module or a software unit module. Accordingly, apparatus 700 may be implemented in various forms. For example, in some embodiments apparatus 700 may be implemented using software and/or firmware partially or completely, e.g., implemented as a computer program product embodied on a computer readable medium. Alternatively or additionally, apparatus 700 may be implemented partially or completely based on hardware, for example, implemented as an integrated circuit (IC) chip, application-specific integrated circuit (ASIC), system on chip (SOC) or field programmable gate array (FPGA). The scope of the present invention is not limited in this regard.

With reference to FIG. 8, this figure illustrates a schematic block diagram of a device 800 which is applicable to implement embodiments of the present invention. According to embodiments of the present invention, device 800 may be any type of fixed or mobile device used for executing face recognition and/or live user recognition. As shown in FIG. 8, device 800 includes: a central process unit (CPU) 801, which may be perform various appropriate actions and processing according to a program stored on a read only memory (ROM) 802 or a program loaded from a storage unit 808 to a random access memory (RAM) 803. In RAM 803, there are further stored various required programs and data for operations performed by device 800. CPU 801, ROM 802 and RAM 803 are coupled to one another via a bus 804. An input/output (I/O) unit 805 is also coupled to bus 804.

One or more units may further be coupled to bus 804: an input unit 806, including a keyboard, mouse, trackball, etc.; an output unit 807, including a display screen, loudspeaker, etc.; storage unit 808, including a hard disk, etc.; and a communication unit 809, including a network adapter like a local area network (LAN) card, modem, etc. Communication unit 809 is used for performing communication process via a network such as the Internet and the like. Alternatively or additionally, communication unit 809 may include one or more antennas for wireless data and/or voice communication. Optionally, a drive 810 may be coupled to I/O unit 805, on which a removable medium 811 may be mounted, such as an optical disk, magneto-optical disk, semiconductor storage medium, etc.

In particular, when the method and process according to embodiments of the present invention is implemented by software, a computer program constituting the software may be downloaded and installed from a network via communication unit 809 and/or installed from removable medium 811.

For the purpose of illustration only, several exemplary embodiments of the present invention have been described above. Embodiments of the present invention can be implemented in software, hardware or combination of software and hardware. The hardware portion can be implemented by using dedicated logic; the software portion can be stored in a memory and executed by an appropriate instruction executing system such as a microprocessor or dedicated design hardware. Those of ordinary skill in the art may appreciate the above system and method can be implemented by using computer-executable instructions and/or by being contained in processor-controlled code, which is provided on carrier media like a magnetic disk, CD or DVD-ROM, programmable memories like a read-only memory (firmware), or data carriers like an optical or electronic signal carrier. The system of the present invention can be embodied as semiconductors like very large scale integrated circuits or gate arrays, logic chips and transistors, or hardware circuitry of programmable hardware devices like field programmable gate arrays and programmable logic devices, or software executable by various types of processors, or a combination of the above hardware circuits and software, such as firmware.

Note although several means or sub-means of the system have been mentioned in the above detailed description, such division is merely exemplary and not mandatory. In fact, according to embodiments of the present invention, the features and functions of two or more means described above may be embodied in one means. On the contrary, the features and functions of one means described above may be embodied by a plurality of means. In addition, although in the accompanying drawings operations of the method of the present invention are described in specific order, it is not required or suggested these operations be necessarily executed in the specific order or the desired result be achieved by executing all illustrated operations. On the contrary, the steps depicted in the flowcharts may change their execution order. Additionally or alternatively, some steps may be omitted, a plurality of steps may be combined into one step for execution, and/or one step may be decomposed into a plurality of steps for execution.

Although the present invention has been described with reference to several embodiments, it is to be understood the present invention is not limited to the embodiments disclosed herein. The present invention is intended to embrace various modifications and equivalent arrangements comprised in the spirit and scope of the appended claims. The scope of the appended claims accords with the broadest interpretation, thereby embracing all such modifications and equivalent structures and functions.

1-17. (canceled)

18. A method for live user recognition, the method comprising:
obtaining an image containing a face;
while recognizing the face based on the image, detecting whether gaze of the face moves into a proximity of a random position on a display screen every time an object is displayed at the random position; and
determining whether the image is obtained from the live user based on the detection.

19. The method of claim 18, wherein detecting whether gaze of the face moves into a proximity of a random position on a display screen every time an object is displayed at the random position comprises:
detecting whether the gaze of the face moves into the proximity of the random position in a predetermined time period after the object is displayed.

20. The method of claim 18, wherein
a first object is displayed at a first random position on the display screen at a first instant;
a second object is displayed at a second random position on the display screen at a subsequent second instant, a distance between the first and second random positions being greater than a predetermined threshold distance.

21. The method of claim 20, wherein the first object is removed from the display screen prior to the second instant.

22. The method of claim 18, wherein the object is displayed on the display screen for a time duration that is less than a predetermined threshold time.

23. The method of claim 18, further comprising:
detecting stay time within which the gaze stays inside the proximity of the random position for determining whether the image is obtained from the live user.

24. The method of claim 18, further comprising:
obtaining at least one parameter indicative of environmental state; and
dynamically adjusting appearance of the object based on the at least one parameter.

25. The method of claim 18, wherein the object differs from background of the display screen in at least one of: color, brightness, shape, and action.

26. An apparatus for live user recognition, the apparatus comprising:
an image obtaining unit configured to obtain an image containing a face;
a gaze detecting unit configured to detect, while recognizing the face based on the image, whether gaze of the face moves into a proximity of a random position on a display screen every time an object is displayed at the random position; and
a live user recognizing unit configured to determine whether the image is obtained from the live user based on the detection.

27. The apparatus of claim 26, wherein the gaze detecting unit comprises:
a unit configured to detect whether the gaze of the face moves into the proximity of the random position in a predetermined time period after the object is displayed.

28. The apparatus of claim 26, wherein
a first object is displayed at a first random position on the display screen at a first instant;
a second object is displayed at a second random position on the display screen at a subsequent second instant, a distance between the first and second random positions being greater than a predetermined threshold distance.

29. The apparatus of claim 28, wherein the first object is removed from the display screen prior to the second instant.

30. The apparatus of claim 26, wherein the object is displayed on the display screen for a time duration that is less than a predetermined threshold time.

31. The apparatus of claim 26, further comprising:
a stay time detecting unit configured to detect stay time within which the gaze stays inside the proximity of the random position for determining whether the image is obtained from the live user.

32. The apparatus of claim 26, further comprising:
an environmental parameter obtaining unit configured to obtain at least one parameter indicative of environmental state; and
an object appearance adjusting unit configured to dynamically adjust appearance of the object based on the at least one parameter.

33. The apparatus of claim 26, wherein the object differs from background of the display screen in at least one of: color, brightness, shape, and action.
